(19) United States
(12) Patent Application Publication
(10) Pub. No.: US 2004/0025133 A1
(43) Pub. Date: Feb. 5, 2004

(54) System and method for integrated circuit design

(76) Inventors: James S. Koford, Mountain View, CA (US); Christopher L. Hamlin, Los Gatos, CA (US); Michael K. Eneboe, San Jose, CA (US)

Correspondence Address: LSI LOGIC CORPORATION, 1621 BARBER LANE, MS: D-106 LEGAL, MILPITAS, CA, 95035, US

(21) Appl. No.: 10/210,188

(22) Filed: Jul. 31, 2002

(51) Int. Cl. G06F 17/50

(52) U.S. Cl. 716/12

(57) ABSTRACT

A method for designing an integrated circuit includes selecting representations of integrated circuit components from a plurality of integrated circuit component representations, the representations suitable for being displayed on a display device. Connections are indicated between at least a portion of the selected representations of the integrated circuit components. An integrated circuit description is provided including the selected representations and the indicated connections between the representations, wherein the integrated circuit description includes data obtained from a database having characteristic data corresponding to the plurality of representations.

### CROSS REFERENCE TO RELATED APPLICATIONS

The present application hereby incorporates the following United Stated Patent Applications by reference in their entirety:

| Attorney Docket Number | Express Mail L.N./U.S.P.N. | Filing Date |
|---|---|---|
| LSI 01-390 | 10/015,194 | Nov. 20, 2001 |
| LSI 01-488 | 10/021,414 | Oct. 30, 2001 |
| LSI 01-489 | 10/021,619 | Oct. 30, 2001 |
| LSI 01-490 | 10/021,696 | Oct. 30, 2001 |
| LSI 01-524B | 10/044,781 | Jan. 10, 2002 |
| LSI 01-543 | 10/135,189 | Apr. 30, 2002 |
| LSI 01-695 | 09/842,335 | Apr. 25, 2001 |
| LSI 01-827 | 10/034,839 | Dec. 27, 2001 |
| LSI 01-828B | 10/061,660 | Feb. 1, 2002 |
| LSI 02-0166 | 10/135,8698 | Apr. 30, 2002 |
| LSI 02-0560 | EV 087 433 682 US | Jun. 27, 2002 |
| LSI 02-4372 | EV 087 433 696 US | Jun. 27, 2002 |
| LSI 02-4466 | EV 087 433 461 US | Jul. 31, 2002 |

### FIELD OF THE INVENTION

The present invention generally relates to the field of integrated circuits, and particularly to a system and method for integrated circuit design.

### BACKGROUND OF THE INVENTION

Integrated circuits (IC) have become an important aspect in an ever increasing array of devices. From network storage systems to washing machines, integrated circuits are relied upon to provide the functionality desired by this wide range of devices. To meet this range of uses, the integrated circuit may be designed specifically to meet a contemplated need, as well as designed to provide functionality desired in a wide range of instances. Thus, the types and functionality desired in integrated circuits is almost limitless.

For instance, an application specific integrated circuit is generally designed for a specific application rather than as a general-purpose chip. The use of application specific integrated circuits improve performance over general-purpose chips, because application specific integrated circuits are “hardwired” to do a specific job, and may thus, not incur the overhead of fetching and interpreting stored instructions. Thus, an application specific integrated circuit may perform an electronic operation in an optimized manner providing that the circuit design is efficiently architected.

However, producing such a wide range of application specific integrated circuits, each having targeted functionality, may be complex, expensive and time consuming. For example, the very size of the circuit, which may include a variety of clock domains, may require extensive testing, verification and redesign before an operational model is produced.

Additionally, general purpose integrated circuits may be designed to provide a function or set of functions that may be used in a wide variety of instances. The function and combination of functions may be tailored for uses in a desired industry, technological area and the like. Therefore, even general purpose integrated circuits may include a wide range of designs and functionality.

Previously, to design this variety of circuits, a labor intensive process was required to decide on components for the desired functionality, arrive at a connectivity scheme for the components, test, perform timing closure, and the like. These problems were further complicated by the increasing size of the circuit and complexity of the integrated circuits, as well as the continued decreases in size of components and introduction of new manufacturing techniques.

Therefore, it would be desirable to provide an environment, implementable as a system and method, for designing an integrated circuit.

### SUMMARY OF THE INVENTION

Accordingly, the present invention is directed to an environment, including a system and method, for designing an integrated circuit. In an aspect of the present invention, a method for designing an integrated circuit includes selecting representations of integrated circuit components from a plurality of integrated circuit component representations, the representations suitable for being displayed on a display device. Connections are indicated between at least a portion of the selected representations of the integrated circuit components. A fabric is designed to supply the indicated connections between the representations, the fabric designed through accessing a database including characteristics of integrated circuit components corresponding to the selected representations so that connections supplied between the integrated circuit components have characteristics corresponding to connectivity requirements stored in the database.

In an additional aspect of the present invention, a system for designing an integrated circuit includes a memory suitable for storing a program of instructions and a processor communicatively coupled to the memory, the processor suitable for performing the program of instructions. The program of instructions configures the processor to supply a graphical user interface including a canvas and a plurality of representations of integrated circuit components. The representations are selectable by a user and are suitable for having indications of connectivity between components indicated by a user.

In a further aspect of the present invention, a system for designing an integrated circuit includes a memory suitable for storing a program of instructions, wherein the memory includes a database having stored therein data corresponding to integrated circuit component characteristics. A processor is communicatively coupled to the memory, the processor suitable for performing the program of instructions. The program of instructions configures the processor to supply a graphical user interface including a canvas and a plurality of representations of integrated circuit components. The representations selectable and manipulable by a user and are suitable for having indications of connectivity between components indicated by a user. The selected representation and indicated connectivity are utilized in conjunction with the database to provide an integrated circuit description having corresponding components and connectivity.

In an aspect of the present invention, a method for designing an integrated circuit includes selecting representations of integrated circuit components from a plurality of integrated circuit component representations, the representations suitable for being displayed on a display device. Connections are indicated between at least a portion of the selected representations of the integrated circuit components. An integrated circuit description is provided including the selected representations and the indicated connections between the representations, wherein the integrated circuit description includes data obtained from a database having characteristic data corresponding to the plurality of representations.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a graphical representation of the relationship between coupled and decoupled circuit designs in relation to specificity of the designs for a purpose;

FIG. 2 is an illustration of an exemplary embodiment of the present invention wherein a design environment including cores, functional blocks and a canvas is shown;

FIG. 3 is an enlarged view of the embodiment shown in FIG. 2 wherein criteria for a connection between components in a design environment is shown;

FIG. 4 is an illustration of an embodiment of the present invention wherein a design environment including components connected in an arrangement desired by a user is shown;

FIG. 5 is an illustration of an embodiment of the present invention shown in FIG. 4 wherein a connection view is shown; and

FIG. 6 is an illustration of an embodiment of the present invention shown in FIG. 4 wherein a fabric view is shown.

### DETAILED DESCRIPTION OF THE INVENTION

Reference will now be made in detail to the presently preferred embodiments of the invention, examples of which are illustrated in the accompanying drawings.

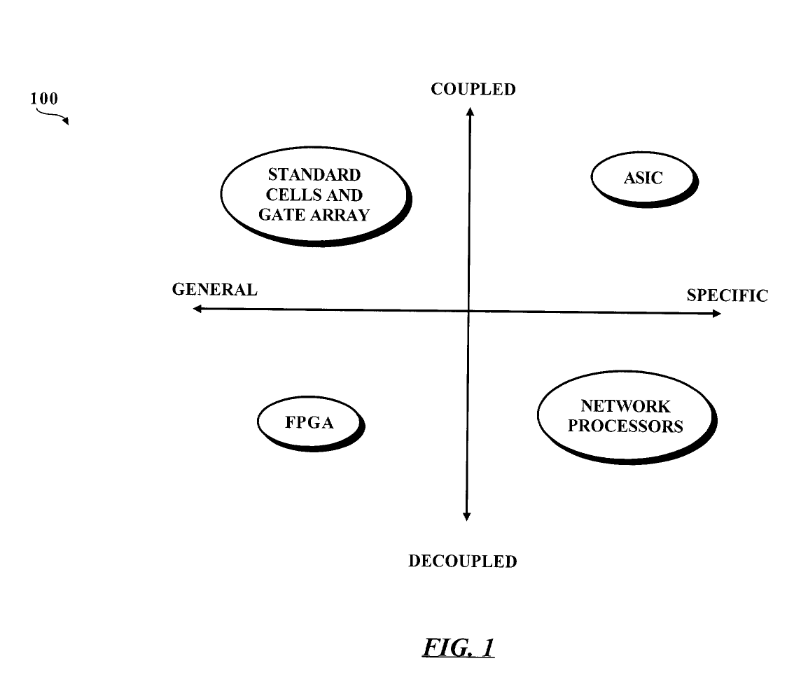

Referring generally now to FIGS. 1 through 6, exemplary embodiments of the present invention are shown. The present invention provides a modern gate array design and delivery environment architecture which may include four components: (1) a gate array architecture itself; (2) a fabric basis for a design environment; (3) an isochronous interconnect in the fabric; and (4) direct manipulation environment for allowing users to assemble gate array solutions. Before those four elements are described in greater detail, the business rationale showing the long-felt need and commercial success expected of the present invention will be discussed.

Growing complexity in time-to-market competition is increasing customers' risks in the market for high-complexity devices. Therefore, the value proposition of integrated circuit manufacture centers more and more on risk mitigation, and profitability depends on the ability to mitigate risks associated with large signs. Customers are willing to pay for better-managed risks in order to get access to complexity in manufactured devices sooner, thereby enabling the customer to be more competitive.

Thus, there is a need to deliver to customers greater value in the form of reduced risk, greater predictability of results, greater predictability in terms of time of delivery to produce the results, greater predictability in the results, success and superior products in point of performance, density, power, function and cost, with quicker time to market.

Preferably, to mitigate risk, customer will become much more actively involved in the design process than has been the case with high-complexity ASIC. Quicker turn times must be provided, such as quicker time to market and better predictability. In other words, once a customer embarks on a design path, how long the process will take and how likely it is to succeed are as predictable as possible. This, in turn, provides an opportunity for commercial success of the present invention through utilization of the design environment which will be described, which allows customers to initiate functional designs. In other words, through use of the present invention, customers may be provided with an architectural environment that allows the customers to actively develop a functional design themselves. In ASIC design, often the customer is not as actively involved in the early stages of functional limitations, but must remain in charge of the overall process of implementation costs and charges.

The present invention provides an architecture that supports lower risks for the customer and faster time to market. To the extent that the present invention reduces risk and delivers a better time to market, the greater the commercial success of the present invention. The present invention provides an architecture that supports higher levels of abstraction in the design process itself, thereby reducing risk and improving time to market.

The business model that the present invention is intended to support is one which is highly automated. The design process is highly automated and imparts active involvement by the customer. Further, the design process may be tailored in some contemplated embodiments to address the level of expertise in the operation of the system expected in the customer.

The architecture of the present invention is intended to support all of those business connectors, and offers powerful technological features, such as quick turn-ins in gate array design once the system is implemented so that the customers may embark on an ambitious project and know that entry into the market in a predictable and efficient amount of time. Preferably, ease of integration, of intellectual property, of IPD and cores, hierarchical design support and quick test and verify cycles, testing verification, and the like of the design process will all be addressed and made more efficient by the present invention. In effect, the present invention may supply a comprehensive implementation of various design components and processes for utilization by a user.

In an embodiment of the present invention, the technology model is an architecture that encompasses a large number of features: a user interface; an interoperability criterion and/or standard for IP core integration; and the designs themselves. Device-level structures, such as structures that are actually implemented in the physical device, including IO, may also be included. A sea of gates, memories, switching fabric, and the associated package may also be included in this overall gate array technology model. Hardware emulation of the functional design during the design process is a key step to allowing customers to take on the responsibility of the functional design. Therefore, support for hardware emulation of the functional design using large-scale, field-programmable audiences may also be implemented.

That present invention also implements and provides a new approach to a partitioning function and timing components and mapping therebetween. The present invention also may supply flow management along the lines of MetaStream, which is further described in the United States Patent Applications which have been incorporated by reference herein; development of specific tools for gate array development; and a new approach to verification.

Preferably, the design environment provided by the business model is one that customers may acquire; that is, which may be purchased or leased (such as through one-time purchase, implementation over a network in a subscription based and/or use service, and the like). Customers may use the design environment to complete functional designs, which differs from current practices significantly. The design environment also supports higher abstraction levels and supports use of and billing for IP in a systematic way. The present invention also enhances productivity and addresses timing verification architecture and the relationship between a customer's functional design activities and implementation of those activities in the form of a gate array product that may be verified, timing closed, tested, and the like.

One of the intentions of this architecture is to allow smaller granularity in the marketplace and allow less-skilled designers at a customer's premises safe access to greater levels of complexity. Preferably, easy access to IP and third-party IP will be provided, which is interoperable with manufacturers' standards, provides support for hardware emulation, implements a simple drag-and-drop model for functional blocks, such as cores IPs, memories, processors and the like, supports for a scalable fabric and fabric architecture, and the like.

In an embodiment of the present invention, a drag-and-drop user interface is provided which includes precharacterized blocks of logic: IP, memory, gate array blocks and so on, processor cores, and the like, a scalable interconnect, an isochronous interconnect, direct emulation and hardware as the functional design is elaborated by the customer, and the like as contemplated by a person of ordinary skill in the art.

From a high-level, conceptual point of view, a customer is involved by creating a functional design specification, expressing it either in schematics or in HDL or the like, and implementing it, from a functional point of view, in a hardware emulation environment provided. The present invention may be sold or leased as a development environment to customers. At the same time, the actual physical instantiation may be a gate array product, which may have radically different physical and timing properties and, in fact, topological properties, as compared to the emulation environment that is supporting the functional development.

The present invention includes a foundation for mapping the design into the environment in a form which permits timing closure to be accomplished rapidly, as well as verification and testing. Mapping is one of the central components of the architecture of the present invention, which allows a customer to cost effectively close functionally even as the necessary underpinnings are being developed, such as the database necessary to close timing given specialized knowledge of the structures and physical properties in the gate array device. This, in turn, provides an efficient turn on the entire development process.

The proposed environment in an embodiment of the present invention centers on three elements: one is a functional design capture environment and software; a second is functional emulation hardware; and a third is the back-end timing and verification environment that uses the functional specification in anticipation of translation into a gate array target vehicle. The environment of the present invention provides a snap-together direct manipulation user environment, which may be implemented through a high-efficiency and scalable interconnect and switching fabric architecture that is utilized to bring the pieces together, and may support a high level of abstraction to increase efficiency.

The rationale may be visualized on the idea of a device space where one axis describes the space between coupled and decoupled designs, as shown in FIG. 1. In other words, “coupled” refers to ultimate functional use of a device as tightly coupled to the manufacturing process of the device, such as in an application specific integrated circuit (ASIC). For instance, the device may not be manufactured before it is known what the design is and how it is going to be used. “Decoupled” refers to physical manufacture of the device that takes place before any thought is given as to how the device will be used in a particular setting.

The present invention contemplates a direct manipulation environment, with snap-together pieces, using a switching fabric, high level of abstraction and isochronous interconnect to provide interoperability between the, the various elements.

In an embodiment of the present invention a user starts with a blank canvas on one side of the screen and a pallet of errant colors and parts on the other side. The user may “drag and drop” cores, which may include a pre-designed hard macro or a block, which is a locally-designed macro, which may be either be soft or hard, onto a canvas and then specify interconnects among the various devices. The devices are known to the system through a database which has information about the devices to instantiate the device, (such as what types of communication characteristics are required, how the devices should be interconnected, and the like).

This information may be obtained automatically, in the background, without user intervention. From this information, which is now specified by the user from the information that is on the canvas, the user has specified the configuration at a fairly high level of abstraction.

Once the user has specified the high-level architecture of the chip, along with the drag-and-drop cores, simulation models and interface models may be employed for simulation, so that the architecture may be synthesized, prototyped and the like. The system then interfaces so that the device may be manufactured and will perform according to the specifications.

In an embodiment of the present invention, there is implicit in the architecture a new timing paradigm involving a way of partitioning elements on the chip so that the timing is simplified. The achievement and convergence of timing of the overall chip will be simplified by these techniques. Another way of looking at this aspect of the environment is to say that the chip design process is approached abstractly, such as to design a modem, multimillion gate IC including a FPGA, gate array, standard cell and the like. To achieve this, the problem may be broken up into two considerations: what will be called the front-end and the back-end of the environment, but which include additional considerations in accordance with the present invention. The front-end involves human interaction, because the users know the desired design and supply creativity in how the technology is applied and what functionality is wanted. The back-end, in an aspect of the present invention, is fully automatic. The front-end in this contemplated embodiment is not fully automatic, because the automatic entity would have to decide what is needed to be built and what features are desired. However, in other contemplated environments, such a front-end may be made increasingly “automatic” as user input is utilized to design an integrated circuit with less and less user interaction and manipulation of elements.

Put another way, the front-end deals with organization of work and the back-end deals with automation. The front end is structured to organize work in a hierarchical abstract fashion. Even though automation is provided behind it, the users are in the design environment.

In the front end, a computer model is being created, which has to be detailed. On the back-end, the abstract model is converted into a real model. To realize this successfully, the abstract model should be correct. In other words, the implementation technology should be known well enough to model it so that if the computer is able to simulate, verify and/or prototype the emulator, the model will match what will happen when implemented in fabrication accurately and correctly. Previously, in chip design and manufacturing, such complexity was not mastered.

Through use of the present invention, complexity will be mastered as the design goes forward. Complexity of chip design may be mastered through partitioning of the problem. For instance, to study a complex field, such as writing, science, music, and the like, the field should be taken apart and the parts learned. Then the parts must be reconstructed in such a way that the desired result is achieved.

Preferably, the environment of the present invention has a modern front end and is tied into a database. To enable ease of user interaction with the mass amounts of data involved in design of an integrated circuit, the present design environment was implemented which may automate such tasks as implementation of a switch and the switching characteristics.

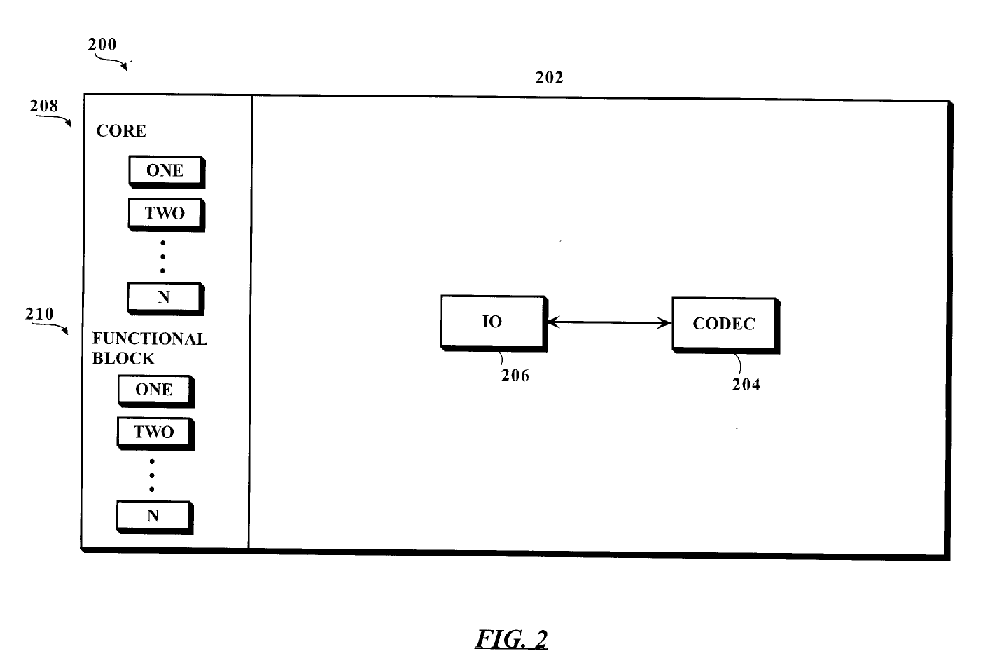

Referring now to FIG. 2, an exemplary embodiment of the present invention is shown wherein a design environment 200 suitable for designing an integrated circuit is shown. The design environment 200 includes a canvas 202 for placement of representation of components of an integrated circuit. For instance, a codec 204 and an IO 206 may be represented.

The user has the two types of elements available as previously described: the core and the functional block. These may be thought of as classes, and not instantiations, (it describes the general block, it does not make it a specific one).

The core 208 is a pre-designed as a hard macro, such as an element that has been designed and tested. For instance, the element may have hundreds of man hours or thousands of man hours of IP behind the block. The core may include a microprocessor, what was in earlier technology a whole chip which has now been made into a hard macro, and the like as contemplated by a person of ordinary skill in the art. Additional functional blocks 210 may be provided, which may include a soft macro or hard macro, which is a block that the customer is designing. In other words, the functional block 210 was not obtained from a library, but rather was designed by the user. In other words, functional blocks may be provided and characteristics supplied by a user as desired.

Thus, a user of the environment provided by the present invention may drag-and-drop representations of elements of an integrated circuit. The representations may trigger access to a database, which includes a number of predefined blocks. Such triggering may be utilized to provide access to the system of the characteristics of the corresponding representation, so that information associated with that block is known to the system and is essentially on the canvas.

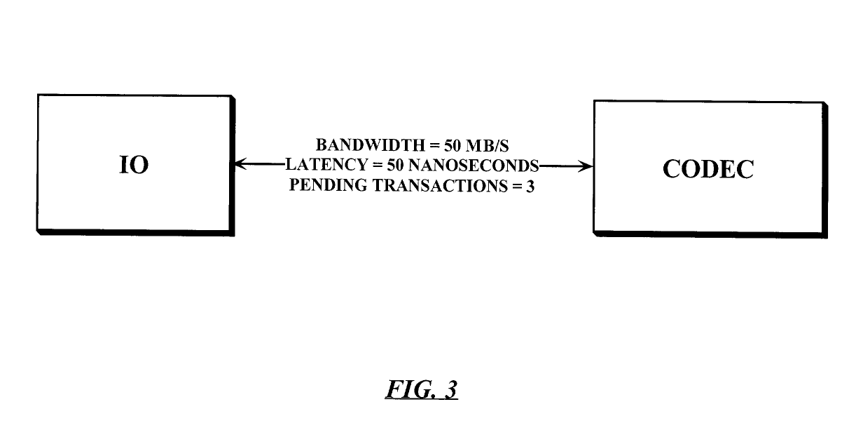

Interconnections may also be specified between the displayed elements. For instance, as shown in FIG. 3, an enlarged view of the components of FIG. 2 is shown wherein an interconnect between the components is viewable. The interconnect between the components shows that bandwidth equals 92 megabits per second, latency equals 50 nanoseconds and pending transactions equals 3. The interconnection properties may be automatically specified by a user. For instance, when specifying the interconnection, the database for both of the connected blocks is examined and communication between the blocks determined, such as the communication that may be supported between those two blocks. Timing closure may also be achieved in a similar manner.

This illustrates an aspect of the present invention wherein the design process is database driven, such that information about a block may be known to the program at this time, and as the design is developed, the structure may be put together automatically. Thus, the front end may provide an environment which is manipulable by a user that may automatically initiate back-end functionality. A variety of other elements may also be included in the design environment, such as an output block (such as Video 2 to 10), a microprocessor, RAM, and the like.

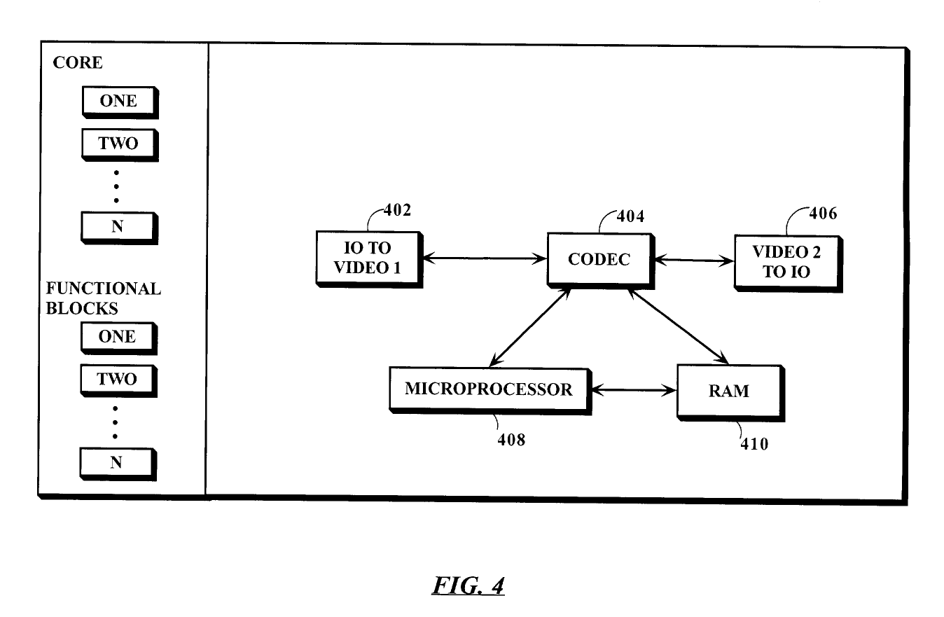

For instance, referring now to FIG. 4, a design environment suitable for designing an integrated circuit is shown. A user may desire to include the functionality of various integrated circuit components, such as an 10 to video 402, a codec 404, video 2 to 10 406, microprocessor 408 and RAM 410. To connect the components, the user may draw arrows in the environments which indicates the desired connectivity between components in this “front-end” environment.

In response to such connectivity, the “back-end” of the environment may access a database to supply the necessary communication characteristics, such as those shown in FIG. 3. In this way, a user may merely indicate the desired connectivity, and have the environment supply the necessary data to implement the functionality in an actual device.

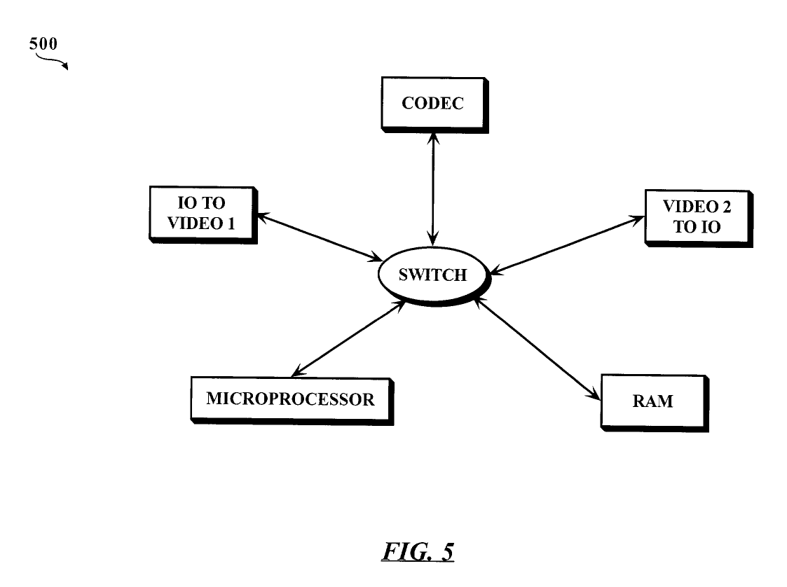

The design environment of the present invention may then supply a connectivity view, as shown in FIG. 5. In this view 500, the elements supplied in FIG. 4 by the user are shown in a manner determined by the environment for connection. In this instance, the units are connected in a switching fabric.

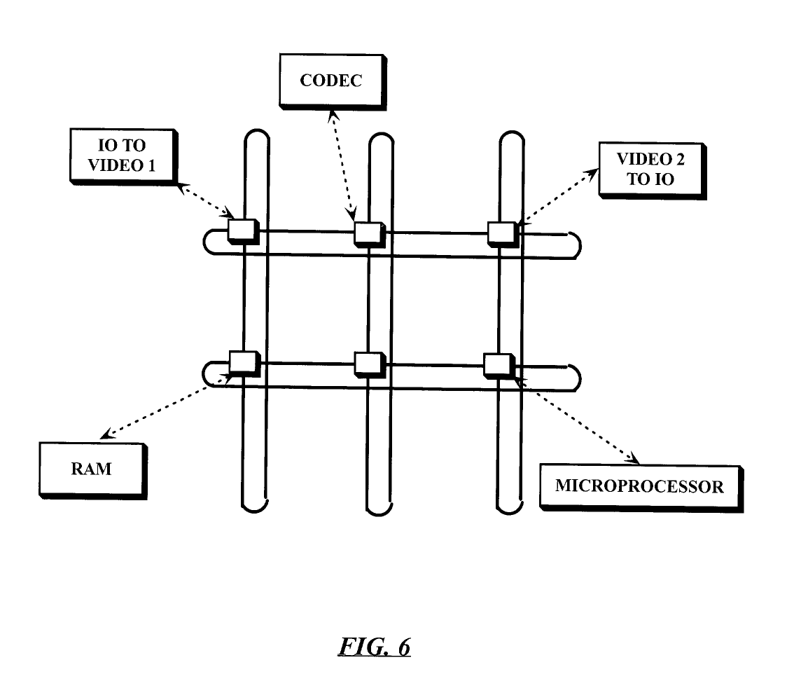

The fabric may then be used by the environment in a fabric view to design a fabric for the devices, as shown in FIG. 6. In this instance, the environment arrived at a Taurus structure for connecting the various components of the integrated circuit. In additional, the fabric may be implemented to supply the connectivity between components as required, such as bandwidth, latency, and the like. For instance, the environment may design a fabric that implements the desired connectivity. Additionally, logic may employ an automation stencil to access the specification that was supplied by the user and utilize a menu of capabilities and employ algorithms that analyze those communications.

It should be noted that the structure shown in FIG. 6 is fully symmetrical in all directions. Additionally, the environment may assign bandwidth between components corresponding to the bandwidths input in the design environment.

Prompting for a desired block and connectivity may also be performed. For example, messages may be provided which indicate which blocks may be connected, types of connections, and the like. A connection, for instance, may be established between components with only 10 megabits a second because a port included by that component may only support that bandwidth. Thus, the characteristics of the connections may be determined by the interconnect, and automation may be used at this stage to take care of the “details”. A user may also be queried for additional information to complete desired arrangements.

With the high-level blocks, there is implicitly some kind of clocking system which makes the blocks perform functions, and there are communication requirements between the various blocks. Thus, there is a specification being developed for the design in an embryonic stage for timing during the creation of the design. In other words, a clocking system may be developed in parallel through the back-end functionality as a user manipulates and defines functional elements.

Even though connectivity may be shown and manipulated between the functional blocks by a user, this indicated functionality may differ from the actual implementation. For example, a fabric may be employed as a central switching fabric which manages and creates the communication channels that the elements require. The fabric may take on a number of different physical implementations. For instance, the fabric may be implemented as a bus and the like. Further, logic may be utilized to find an optimal arrangement, even asymmetrical arrangements which may be found optimal based on the encountered implementation. Thus, the specification may be utilized in conjunction with logic to optimize the arrangement and connectivity of the components.

The present invention provides a database that can describe complex laws of the interactions and functionality of the chip components. In this way, a user of the environment of the present invention is not confronted unnecessarily detailed information to the design of the integrated circuit for a “high-level” design, yet the information is ava ilable for the actual implementation, testing and verification of the design.

The fabric view may include a type of table lookup. Configuration is selective, but the routing is not. The number of assignments in the detailed routing is algorithmic. There are lots of different algorithms you could use and the graphics can be totally algorithmic, too.

The database that drives the design environment may include information on blocks, connections and cores and includes parameters for new blocks, such as blocks custom designed by a user. Thus, a user may add objects and capability as objects and capability become known, but the user need not “build” the system to support this capability. Therefore, the database is scalable, and may be employed as a real access database, to look at information, read it, and then output the desired information or representation of the information. Additionally, a Metastream architecture may be provided in the environment of the present invention, as mentioned in the application incorporated by reference.

First of all, in the matter of switch topology, one of the important considerations about fabrics of this kind is that the fabrics may scale not only in the size of the X or the Y dimension, but may also scale in a number of dimensions, and have important properties that change as the scale of the dimension changes. Higher-dimensional hypercubes and other multidimensional structures may be employed by the present invention, in more than three dimensions, to adequately and/or optimally exploit the complexity of devices as design progress is made along the technology road map. For instance, depending on the topology by which ports of devices are connected and the corresponding adjacency, hypercubes may be defined in five or more dimensions, and those could be realized on a two-dimensional chip. Thus, it is a function of the number of ports and the structure of interconnections to neighboring devices.

In this way, the whole architecture is conceived to scale in dimensionality, as well as in number of nodes and the bandwidth and the characteristics of the nodes. The switching traffic may be thought of as having three aspects: (1) dimensionality; (2) timing model that is used for interconnect and the individual nodes; and (3) the third is the address. Each node has to have a deterministic methodology for addressing. One of the deepest problems that this architecture will be directed at is optimizing simultaneously all three of those aspects: dimensionality, timing and addressing. Optimal solutions may end up being a lot less regular and in fact, irregular structures may emerge as structures are designed. Therefore, a methodology may be employed, such as a genetic methodology, for discovering irregular structures that exhibit optimal characteristics. Genetic programming algorithms may be applied to the discovery of irregular structures in higher-dimensional fabrics as designs progress, particularly as it pertains to the relationship between dimensionality and addressing.

The role of timing and signaling, as connecting the various elements, may also be pivotal to the design. For instance, in at least in a certain class of devices, isochronous signaling may be important as the fundamental timing architecture for providing signaling between the individual nodes within the switching fabrics. An isochronous model, (a clocked model, where there is a universal criterion for time and for definition of edges) can be virtualized. It is a virtualizable model of time that can be used in hierarchical frameworks more readily than a more traditional clock-tree approach, where a tree is propagated, sometimes to incredible numbers of domains and nodes.

The present invention may also employ methods for explicitly extracting “hints” from the functional and/or emulation of the hardware design, as previously discussed. For instance, as the customer is works at perfecting the functional emulation in hardware of the design, hints may be extracted that permit exploitation of an isochronous interconnect fabric as a vehicle for closing timing over these enormously complex structures that unify functional blocks, according to the kind of algorithm implemented. By examining the local timing properties of isolatable functional blocks as the blocks are synthesized and accepted in the functional level, a local understanding may be derived of the timing implications for the global integration of time in an isochronous framework, which may be implemented in the gate array instantiation. As the customer is actually perfecting the functional realization in the hardware emulation, the customer may not be made aware that the software is operating through use of the software in the background, deriving hints and insights into local timing characteristics and exporting the hints for later use. This may be thought of a form of parallel synthesis. Additionally, through use of the switching parameters and related information, the problem may be partitioned.

Thus, a universal understanding of what time is and what time base is provided, through use of a protocol which permits various elements within the logical design to float free of that universal base as needed, for simplification purposes, but allows an arbitrary degree of precision as desired. In other words, the arbitrary degree of precision may be provided by employing an isochronous model to get the simultaneous benefit of simplification and timing closure in the overall functional design. Additionally, the environment may be hierarchicalized, so that the environment may be collapsed into a bigger model.

The present invention provides a connection between how devices are conceived, on the one hand, and the environment defined for direct manipulation. This combination of direct manipulation of logical blocks, the underlying database description of the blocks, their timing specification, as well as the representation of the timing relationships is a novel construct. The present invention provides a graphical environment and direct manipulation mechanisms which map onto the subject devices and cells.

Communication need not be predetermined ahead of time, rather, it is synthesized during the design process. Through use of the design environment of the present invention, when specifying blocks, the communication requirements of the blocks may be known or subsequently determined. In this case, there is a statistical nature, but because of the blocks, the environment may determine what the demands on a switch will be at any entry or exit point, and thus gives a greater amount of flexibility in designing a switch.

Additionally, the present invention may employ heuristics for the protocol and scheduling. Such heuristics may be useful in optimizing the structure as well as the design environment itself.

In exemplary embodiments, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

Although the invention has been described with a certain degree of particularity, it should be recognized that elements thereof may be altered by persons skilled in the art without departing from the spirit and scope of the invention. One of the embodiments of the invention can be implemented as sets of instructions resident in the memory of one or more information handling systems, which may include memory for storing a program of instructions and a processor for performing the program of instruction, wherein the program of instructions configures the processor and information handling system. Until required by the information handling system, the set of instructions may be stored in another readable memory device, for example in a hard disk drive or in a removable medium such as an optical disc for utilization in a CD-ROM drive and/or digital video disc (DVD) drive, a compact disc such as a compact disc-rewriteable (CD-RW), compact disc-recordable and erasable; a floppy disk for utilization in a floppy disk drive; a floppy/optical disc for utilization in a floppy/optical drive; a memory card such as a memory stick, personal computer memory card for utilization in a personal computer card slot, and the like. Further, the set of instructions can be stored in the memory of an information handling system and transmitted over a local area network or a wide area network, such as the Internet, when desired by the user.

Additionally, the instructions may be transmitted over a network in the form of an applet that is interpreted or compiled after transmission to the computer system rather than prior to transmission. One skilled in the art would appreciate that the physical storage of the sets of instructions or applets physically changes the medium upon which it is stored electrically, magnetically, chemically, physically, optically or holographically so that the medium carries computer readable information.

It is believed that the system and method of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A method for designing an integrated circuit, comprising:
selecting representations of integrated circuit components from a plurality of integrated circuit component representations, the representations suitable for being displayed on a display device;
indicating connections between at least a portion of the selected representations of the integrated circuit components; and
designing a fabric to supply the indicated connections between the representations, the fabric designed through accessing a database including characteristics of integrated circuit components corresponding to the selected representations so that connections supplied between the integrated circuit components have characteristics corresponding to connectivity requirements stored in the database.

2. The method as described in claim 1, wherein the connections are indicated by a user.

3. The method as described in claim 1, wherein the fabric is designed by a system automatically and without user intervention based on the indicated connections and selected representations.

4. The method as described in claim 1, further comprising extracting data suitable for describing the integrated circuit, the data including the fabric design, connection characteristics between components, and data describing the components.

5. The method as described in claim 1, wherein the fabric is designed to supply timing closure.

6. A system for designing an integrated circuit, comprising:
a memory suitable for storing a program of instructions; and
a processor communicatively coupled to the memory, the processor suitable for performing the program of instructions, wherein the program of instructions configures the processor to supply a graphical user interface including a canvas and a plurality of representations of integrated circuit components, the representations selectable by a user and are suitable for having indications of connectivity between components indicated by a user.

7. The system as described in claim 6, wherein the memory includes a database having stored therein data corresponding to integrated circuit component characteristics so that the indicated connectivity and selected components are utilized in conjunction with the database to provide an integrated circuit description suitable for at least one of testing, verifying and manufacturing an integrated circuit corresponding to the description.

8. The system as described in claim 6, further comprising designing a fabric to supply the indicated connections between the representations, the fabric designed through accessing a database including characteristics of integrated circuit components corresponding to the selected representations so that connections supplied between the integrated circuit components have characteristics corresponding to connectivity requirements stored in the database.

9. The system as described in claim 8, wherein the fabric is designed by a system automatically and without user intervention based on the indicated connections and selected representations.

10. The system as described in claim 8, further comprising extracting data suitable for describing the integrated circuit, the data including the fabric design, connection characteristics between components, and data describing the components.

11. The system as described in claim 8, wherein the fabric is designed to supply timing closure.

12. A system for designing an integrated circuit, comprising:
a memory suitable for storing a program of instructions, wherein the memory includes a database having stored therein data corresponding to integrated circuit component characteristics; and
a processor communicatively coupled to the memory, the processor suitable for performing the program of instructions, wherein the program of instructions configures the processor to supply a graphical user interface including a canvas and a plurality of representations of integrated circuit components, the representations selectable and manipulable by a user and suitable for having indications of connectivity between components indicated by a user, wherein the selected representation and indicated connectivity are utilized in conjunction with the database to provide an integrated circuit description having corresponding components and connectivity.

13. The system as described in claim 12, wherein the indicated connectivity and selected components are utilized in conjunction with the database to provide an integrated circuit description suitable for at least one of testing, verifying and manufacturing an integrated circuit corresponding to the description.

14. The system as described in claim 12, wherein the description includes a fabric to supply the indicated connections between the representations, the fabric designed through accessing a database including characteristics of integrated circuit components corresponding to the selected representations so that connections supplied between the integrated circuit components have characteristics corresponding to connectivity requirements stored in the database.

15. The system as described in claim 14, wherein the fabric is designed by a system automatically and without user intervention based on the indicated connections and selected representations.

16. The system as described in claim 14, further comprising extracting data suitable for describing the integrated circuit, the data including the fabric design, connection characteristics between components, and data describing the components.

17. The system as described in claim 14, wherein the fabric is designed to supply timing closure.

18. A method for designing an integrated circuit, comprising:
selecting representations of integrated circuit components from a plurality of integrated circuit component representations, the representations suitable for being displayed on a display device;
indicating connections between at least a portion of the selected representations of the integrated circuit components; and
providing an integrated circuit description including the selected representations and the indicated connections between the representations, wherein the integrated circuit description includes data obtained from a database having characteristic data corresponding to the plurality of representations.

19. The method as described in claim 18, wherein the indicated connectivity and selected components are utilized in conjunction with the database to provide an integrated circuit description suitable for at least one of testing, verifying and manufacturing an integrated circuit corresponding to the description.

20. The method as described in claim 18, wherein the description includes a fabric to supply the indicated connections between the representations, the fabric designed through accessing a database including characteristics of integrated circuit components corresponding to the selected representations so that connections supplied between the integrated circuit components have characteristics corresponding to connectivity requirements stored in the database.

21. The method as described in claim 20, wherein the fabric is designed by a system automatically and without user intervention based on the indicated connections and selected representations.

22. The method as described in claim 20, further comprising extracting data suitable for describing the integrated circuit, the data including the fabric design, connection characteristics between components, and data describing the components.

23. The method as described in claim 20, wherein the fabric is designed to supply timing closure.
